(19) United States
(12) Patent Application Publication
(10) Pub. No.: US 2003/0195134 A1
(43) Pub. Date: Oct. 16, 2003

(54) Detergent granule comprising a nonionic surfactant and a hydrotrope

(75) Inventors: Paul Irma Albertus Vandijk, Putte (BE); Jose Luis Vega, Strombeek-Bever (BE)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/402,632

(22) Filed: Mar. 28, 2003

(30) Foreign Application Priority Data
Apr. 11, 2002 (EP) 02 447 065.0

(51) Int. Cl. C11D 17/00

(52) U.S. Cl. 510/446; 510/421

(57) ABSTRACT

The present invention relates to a detergent granule comprising a surfactant system comprising at least 10% by weight of said surfactant system, of a nonionic surfactant and a specific hydrotrope. Said granule demonstrates better dissolution and/or lower residue formation. The present invention further relates to detergent compositions comprising said granule.

### CROSS REFERENCE TO RELATED APPLICATIONS

This application claims priority under 35 U.S.C. § 119(e) to European Patent Office Serial No. 02447065.0, filed Apr. 11, 2002 (Attorney Docket No. CM2658F).

### FIELD OF THE INVENTION

The present invention relates to a detergent granule comprising a nonionic surfactant and a specific hydrotrope. The present invention further relates to a detergent composition comprising said granule.

### BACKGROUND OF THE INVENTION

It is frequently desired to include nonionic surfactants in detergent compositions because they provide a number of benefits in comparison to other surfactants. Nonionic surfactants are less sensitive to water hardness, provide a better foam profile in aqueous solutions, show a good biodegradability, provide excellent cleaning even in cold water solutions, and are particularly effective in removing silts, clays and oily stains. However, the physical properties of the nonionic surfactants make it difficult to include high levels thereof in detergent granules. Nonionic surfactants tend to form viscous phases or gels upon contact with water. Thus, relatively large amounts of undissolved nonionic surfactants can be observed in the wash liquor. Such undissolved nonionic surfactants form viscous phases or gels and then can deposit onto the fabric. These undissolved nonionic surfactants are undesirable since they slow down or inhibit the dissolution of the surfactant in the wash liquor, and hence, delay the detergency action. This gelling behavior has been particularly observed in particulate or granular detergent compositions, as well as in tablet detergent compositions. Moreover, deposition of undissolved nonionic surfactants onto the fabric can occur and leave residues on the washed garments.

The prior art offers different solutions to improve the dissolution properties of the nonionic surfactants: to lower the content of nonionic surfactants; to include dissolution aids into the detergent composition or into the detergent granule. For example:

EP 971 028 (P&G, published Jan. 12, 2000) discloses a tablet formed by compressing conventional detergent ingredients with a hydrotrope as a binder such as alkali metal C₃-C₈ alkyl- and dialkylaryl sulfonates. WO 01/48131 (Cognis, published on Jul. 5, 2001) describes surfactant granules with improved disintegration rate. Said granules comprise a mixture of anionic and nonionic surfactants up to 50% by weight and disintegrants up to 75% by weight. Such disintegrants are carbonate/citric acid mixtures, synthetic or natural polymers like polyvinylpyrrolidone, cellulose, starch and their derivatives. EP 694 608 (P&G, published Jan. 31, 1996) discloses a process for making a detergent granule via a pumpable premix, comprising a nonionic surfactant up to 70% by weight, polyhydroxy fatty acid amide of at least 3% by weight and a structuring agent of from 0.1% to 20% by weight. Said structuring agent has a melting point above 40° C. and is selected from the group consisting of glycerides and polyglycerides. WO 98/31780 (P&G, published Jul. 31, 1998) discloses surfactant granules, wherein the nonionic surfactant is in the form of various sorbitan ester encased in a matrix of a plastic, organic structuring agent that can be readily dissolved or dispersed in an aqueous laundry bath. WO 94/25553 (P&G, published Nov. 10, 1994) discloses surfactant granules comprising 10% to 50% by weight of nonionic surfactant and 5% to 30% by weight of a structuring agent selected from sugars, artificial sweeteners, polyvinyl alcohols, polyhydroxyacrylic acid polymers, and their derivatives; and polyvinyl pyrrolidone, PVNO, phtalimide, para-toluene sulphonamide, maleimide, and mixtures of these. WO 95/23205 (P&G, published Aug. 31, 1995) discloses an anionic agglomerate comprising a surfactant, a hydrotrope selected from sulfyl succinates, xylene and cumene sulfonates and mixtures thereof and a builder, wherein at least 30% by weight of the surfactant is a sulfated surfactant.

However, it has been found that such detergent compositions comprising nonionic surfactants and dissolution aids either in the composition or even in the granule, still form viscous phases or gels upon contact with water and consequently leave residues of undissolved nonionic surfactants.

It is therefore the object of the present invention to provide a detergent granule which comprises a nonionic surfactant, which demonstrates better dissolution and/or lower residue formation. It has been surprisingly found that a detergent granule which comprises a nonionic surfactant and a specific hydrotrope overcome such problems of poor dissolution of the nonionic surfactants. Such detergent granule is highly soluble, does not gel upon contact with water and hence provide the full cleaning potential of the nonionic surfactants and show reduced residue of undissolved nonionic surfactant onto the fabric.

### SUMMARY OF THE INVENTION

The present invention relates to a detergent granule comprising

(a) a surfactant system comprising at least 10% by weight of said surfactant system, of a nonionic surfactant; and,

(b) a hydrotrope selected from the group consisting of unsubstituted- and substituted-phenyl, benzyl, alkyl, and alkenyl carboxylic acid and salts thereof; unsubstituted- and substituted-phenyl, benzyl, alkyl, and alkenyl sulfonic acid and salts thereof; unsubstituted- and substituted-phenyl, benzyl, alkyl, and alkenyl sulfuric acid and salts thereof; and mixtures thereof.

The present invention further provides a detergent composition, comprising the above granule. Furthermore, the present invention discloses the use of such hydrotrope in a nonionic surfactant detergent granule for improved dissolution. The present invention further relates to a method of making such detergent granule comprising the step of mixing such a hydrotrope with the nonionic surfactant.

### DETAILED DESCRIPTION OF THE INVENTION

The present invention relates to a detergent granule, wherein said granule comprises a surfactant system comprising at least 10% by weight of said surfactant system, of a nonionic surfactant and a selected hydrotrope. It has been surprisingly found that the addition of such selected hydrotrope improves the dissolution profile of a nonionic surfactant detergent granule. Such granule is highly soluble in aqueous compositions, even at high levels of nonionic surfactant present in the detergent granule. The granule does not gel upon contact with water, is fully dissolved in the wash liquor and avoid the deposition of residues of undissolved nonionic surfactant on fabrics. Without being bound by theory, it is believed that the hydrotrope of the present invention forms layers within the nonionic surfactant, these layers of hydrotropes easily dissolve upon contact with water and help to dissolve the nonionic surfactant in the aqueous medium.

As used herein, the term “substituted” means: substituted by any suitable substituent, such as chloride, bromide, iodide, C₁-C₆ branched or linear hydrocarbon and hydroxy, preferably C₁-C₄ alkyl and hydroxy.

As used herein, the term “salts thereof” means: sodium, potassium or ammonium salts of the respective compound, preferably sodium salts of the respective compound.

Nonionic Surfactants

The detergent granule of the present invention comprises a surfactant system, which comprises at least 10% by weight of said surfactant system of a nonionic surfactant. Preferably the nonionic surfactant is comprised at a level of at least 25% by weight, more preferably at least 50% by weight and more preferably at least 75% by weight of said surfactant system.

Typically any nonionic surfactant useful for detersive purposes that is liquid below 80° C., preferably below 60° C., more preferably below 45° C. is included in the granule. Preferred nonionic surfactants for use herein are described in more detail hereinafter. More commonly used for the purpose of the present invention are the alkylpolyethoxylates, like the commercially available Neodol® 23-AE 5, Neodol® 45-AE 5, Neodol® 45-AE 7, Lialet® 125-AE 3, Lialet® 123-AE 3, Lialet® 123-AE 5, Lialet® 125-AE 5

The granule of the present invention typically comprises the surfactant system at a level of from 10% to 90% by weight, preferably from 20% to 70% by weight, more preferably from 25% to 50% by weight of the granule.

Suitable nonionic surfactants for the purpose of the present invention are described below:

Nonionic Non-End Capped Ethoxylated Alcohol Surfactant

The alkyl ethoxylate condensation products of aliphatic alcohols with from 1 to 25 moles of ethylene oxide are suitable for use herein. The alkyl chain of the aliphatic alcohol can either be straight or branched, primary or secondary, and generally contains from 6 to 22 carbon atoms, preferably from 12 to 17 carbon atoms, even more preferably from 14 to 15 carbon atoms. Particularly preferred are the condensation products of alcohols having an alkyl group containing from 12 to 17 carbon atoms, preferably from 14 to 15 carbon atoms, with from 3 to 12, more preferably from 5 to 9 moles of ethylene oxide per mole of alcohol.

End-Capped Alkyl Alkoxylate Surfactant

A suitable nonionic surfactant for use herein is an endcapped alkyl alkoxylate surfactant, preferred is the epoxy-capped poly(oxyalkylated) alcohols represented by the formula:

R₁O[CH₂CH(CH₃)O]ₓ[CH₂CH₂O]_{y}[CH₂CH(OH)R₂] (I)

wherein R₁O is an epoxy group wherein, R₁ is a linear or branched, aliphatic hydrocarbon radical having from 4 to 18 carbon atoms; R₂ is a linear or branched aliphatic hydrocarbon radical having from 2 to 26 carbon atoms; x is an integer having an average value of from 0.5 to 1.5, more preferably 1; and y is an integer having a value of at least 15, more preferably at least 20.

Preferably, the nonionic surfactant of formula I, comprises at least 10 carbon atoms in the terminal epoxide unit [CH₂CH(OH)R₂]. Suitable nonionic surfactants of formula I, for use herein, are Olin Corporation's POLY-TERGENT® SLF-18B nonionic surfactants, as described, for example, in WO 94/22800, published Oct. 13, 1994 by Olin Corporation.

Ether-Capped Poly(oxyalkylated) Alcohols

Preferred nonionic surfactants for use herein, include ether-capped poly(oxyalkylated) alcohols having the formula:

R¹O[CH₂CH(R³)O]ₓ[CH₂]ₖCH(OH)[CH₂]ⱼOR²

wherein R¹ and R² are linear or branched, saturated or unsaturated, aliphatic or aromatic hydrocarbon radicals having from 1 to 30 carbon atoms; R³ is H, or a linear aliphatic hydrocarbon radical having from 1 to 4 carbon atoms; x is an integer having an average value from 1 to 12, wherein when x is 2 or greater R³ may be the same or different and k and j are integers having an average value of from 1 to 12, and more preferably 1 to 5.

R¹ and R² are preferably linear or branched, saturated or unsaturated, aliphatic or aromatic hydrocarbon radicals having from 6 to 22 carbon atoms with 8 to 18 carbon atoms being most preferred. H or a linear aliphatic hydrocarbon radical having from 1 to 2 carbon atoms is most preferred for R³. Preferably, x is an integer having an average value of from 1 to 9, more preferably from 3 to 7.

As described above, when x is greater than 2, R³ may be the same or different. That is, R³ may vary between any of the alklyeneoxy units as described above. For instance, if x is 3, R³ may be selected to form ethlyeneoxy(EO) or propyleneoxy(PO) and may vary in order of (EO)(PO)(EO), (EO)(EO)(PO); (EO)(EO)(EO); (PO)(EO)(PO); (PO)(PO)(EO) and (PO)(PO)(PO). Of course, the integer three is chosen for example only and the variation may be much larger with a higher integer value for x and include, for example, multiple (EO) units and a much small number of (PO) units.

Particularly preferred nonionic surfactants include those that have a low cloud point of less than 20° C.

Most preferred ether-capped poly(oxyalkylated) alcohol surfactants are those wherein k is 1 and j is 1 so that the surfactants have the formula:

R¹O[CH₂CH(R³)O]ₓCH₂CH(OH)CH₂OR²

where R¹, R² and R³ are defined as above and x is an integer with an average value of from 1 to 12, preferably from 1 to 9, and even more preferably from 3 to 7. Most preferred are surfactants wherein R¹ and R² range from 9 to 14, R³ is H forming ethyleneoxy and x ranges from 1 to 9.

The ether-capped poly(oxyalkylated) alcohol surfactants comprise three general components, namely a linear or branched alcohol, an alkylene oxide and an alkyl ether end cap. The alkyl ether end cap and the alcohol serve as a hydrophobic, oil-soluble portion of the molecule while the alkylene oxide group forms the hydrophilic, water-soluble portion of the molecule.

Generally speaking, the ether-capped poly(oxyalkylene) alcohol surfactants suitable for use herein may be produced by reacting an aliphatic alcohol with an epoxide to form an ether which is then reacted with a base to form a second epoxide. The second epoxide is then reacted with an alkoxylated alcohol to form the novel compounds of the present invention.

Nonionic Ethoxylated/Propoxylated Fatty Alcohol Surfactant

The ethoxylated C₆-C₁₈ fatty alcohols and C₆-C₁₈ mixed ethoxylated/propoxylated fatty alcohols are suitable surfactants for use herein, particularly where water-soluble. Preferably the ethoxylated fatty alcohols are the C₁₀-C₁₈ ethoxylated fatty alcohols with a degree of ethoxylation of from 1 to 12, most preferably these are the C₁₂-C₁₈ ethoxylated fatty alcohols with a degree of ethoxylation from 1 to 9. Preferably the mixed ethoxylated/propoxylated fatty alcohols have an alkyl chain length of from 10 to 18 carbon atoms, a degree of ethoxylation of from 3 to 9 and a degree of propoxylation of from 1 to 10.

Hydrotrope

The detergent granule of the present invention further comprises a selected hydrotrope. As commonly understood by persons skilled in the art, the term “hydrotrope” refers to any compound which helps to dissolve other compounds in a liquid medium.

It has been found that the use of the selected hydrotropes of the present invention into a nonionic surfactant granule helps the dissolution of the nonionic surfactant granule in the wash liquor.

The granule of the present invention typically comprises the selected hydrotrope at a level of from 10% to 90% by weight, preferably from 20% to 80% by weight, more preferably from 25% to 60% by weight of the granule.

The hydrotrope of the present invention is selected from unsubstituted- and substituted-phenyl, benzyl, alkyl, and alkenyl carboxylic acid and salts thereof; unsubstituted- and substituted-phenyl, benzyl, alkyl, and alkenyl sulfonic acid and salts thereof; unsubstituted- and substituted-phenyl, benzyl, alkyl, and alkenyl sulfuric acid and salts thereof; and mixtures thereof.

Preferably the hydrotrope is selected from C₁-C₄ aryl sulfonate acid salts and mixtures thereof. More preferably said hydrotrope is a C₁-C₄ linear or branched alkyl aryl sulfonate acid salt, wherein said C₁-C₄ linear or branched alkyl group is in ortho-, meta-, or para-position at the aryl ring (in relation to the sulfonate acid salt group). Most preferably said hydrotrope is selected from ortho-, meta- or para-toluene sulfonic acid sodium salt, xylene sulfonic acid sodium salt, cumene sulfonic acid sodium salt, benzene sulfonic acid sodium salt, ethylbenzene sulfonic acid sodium salt, disodium 1,3 benzenedisulfonate, and/or mixtures thereof.

The hydrotrope regardless of form (i.e. solid, liquid, or paste) is mixed with the nonionic surfactant to form the detergent granule of the present invention. Preferably such hydrotrope is mixed within the nonionic surfactant which is in a liquid form.

In a preferred embodiment of the present invention, the nonionic surfactant and the hydrotrope are finely mixed with each other, more preferably the nonionic surfactant of the granule and the hydrotrope of the granule are finely dispersed in each other. When the granules of the present invention comprises further ingredients such as the hardening ingredient and the stickiness breaking material described herein below, those are as well finely dispersed.

Hardening Ingredient

The granule of the present invention preferably further comprises a hardening ingredient. As commonly understood by persons skilled in the art, the term “hardening ingredient” refers to any material which gives a higher hardness and/or a higher resistance to breakage and/or to deformation. It has been found that the use of a hardening ingredient provides a higher stiffness and higher resistance to scratching, abrasion or cutting.

Suitable hardening ingredients for the present invention are compound having a melting point above 30° C., preferably above 40° C., most preferably between 42° C. and 70° C. and being selected from the group consisting of polyethylene glycols, polyethylene glycol esters, fatty alcohols alkoxylates, fatty acids and salts thereof, alkyl esters of sulfo fatty acids, glucose amides, amides, sorbitan esters, glycerol esters, and polyglycol ethoxylated/propoxylated copolymers and/or mixtures thereof. Fatty acids suitable for the purpose of the present invention generally have from 10 to 22 carbon atoms, can be substituted- and/or unsubstituted-, saturated- and/or unsaturated-fatty acids.

Preferred hardening ingredient are selected from the group consisting of polyethylene glycols, glucose amides, fatty acids and salts thereof, amides, sorbitan esters, and polyglycol ethoxylated/propoxylated copolymers and mixtures thereof. More preferred hardening ingredients are selected from the group consisting of saturated fatty acids and salts thereof with 12 to 20 carbon atoms; and polyethylene glycols having a molecular weight between 2,500 and 10,000. Most preferred hardening ingredients are the lauric acid, lauric acid sodium salt, myristic acid, myristic acid sodium salt, palmitic acid, palmitic acid sodium salt, ricinoleic acid and ricinoleic acid sodium salt, stearic acid and/or stearic acid sodium salt and polyethylene glycols having a molecular weight between 3,500 and 5,000.

When present, the hardening ingredient is generally included in the granule of the present invention at a level of from 1% to 50% by weight, preferably from 5% to 30% by weight, more preferably from 10% to 20% by weight of the granule.

Stickiness Breaking Material

The detergent granule of the present invention can further comprise a stickiness breaking material. As commonly understood by persons skilled in the art the terms “stickiness breaking material” refer to any material which helps breaking the adhesion of granules or powders and rendering them more free flowing, in particular when mixed with the granules or powders.

Suitable stickiness breaking materials for the present invention are zeolites, silicas, clays, amorphous silicates, fatty acid salts, i.e. calcium stearate, and magnesium stearate; titanium dioxide, calcium carbonate, cellulose, phosphates, crystalline non layered silicates, layered silicates, calcium/sodium carbonate double salt, sodium carbonate, alkali metal phosphonates, carboxyl alkyl celluloses, carboxyl alkyl starches, tetrasodium phosphate, citrates, and/or alkali metal sulfates, and/or mixtures thereof.

Preferred stickiness breaking materials are zeolites, silicates, and/or layered silicates, more preferred are zeolites, and mixtures thereof.

When present, the stickiness breaking material is typically included in the granule of the present invention at a level of from 1% to 20% by weight, preferably from 2% to 10% by weight, more preferably from 3% to 5% by weight of the granule.

Detergent Ingredients and Composition

The detergent granule of the present invention may also comprise additional components. The detergent granule can be further incorporated in any detergent composition which can also comprise further ingredients. Such ingredients are additional surfactant, e.g. anionic, cationic, amphoteric and zwitterionic surfactants; builder, perfume, fabric softening agents, enzymes, optical brighteners, a bleaching system, chelating agents, suds suppressor or any other material or mixture of materials suitable for a detergent granule. Also suitable are for example, wrinkle reducing agents, fabric abrasion reducing polymers, chlorine scavengers, dye fixing agents, antifoam compounds, polymeric dye transfer inhibiting agents, soil release agents, clay softening system, alkali metal silicate, colorant, lime soap dispersant, and compatible mixtures thereof.

The detergent granules of the present invention can be incorporated in any detergent composition, typically at a level of from 0.1% to 50% by weight, preferably from 0.5% to 40% by weight, more preferably from 1% to 35% by weight of the detergent composition.

The detergent compositions of the present invention are usually in the form of a granular, a powder or a tablet composition as described herein later. Detergent compositions and methods of producing them are well-known in the art. As mentioned above, they usually comprise further surfactant, enzymes, bleaches, fabric softeners, builders, perfumes, chelating agents, etc. Some of the preferred optional ingredients are described below.

(a) Surfactants

The detergent granule of the present invention may further comprise other surfactants than nonionic surfactants. Also, the detergent composition wherein the detergent granule of the present invention can be incorporated can further comprise other surfactants than nonionic surfactants. Said surfactant is selected from the group consisting of anionic, cationic, zwitterionic, ampholytic surfactants, and mixtures thereof. Within each category of surfactant, more than one type of surfactant can be selected. The surfactant is preferably present to the extent of from 0.1% to 60%, preferably to 30% by weight of the detergent composition or by weight of the granule.

Nonlimiting examples of surfactants useful herein include:

a) C₁₁-C₁₈ alkyl benzene sulfonates (LAS);

b) C₁₀-C₂₀ primary, branched-chain and random alkyl sulfates (AS);

c) C₁₀-C₁₈ secondary (2,3) alkyl sulfates having the formula:

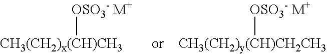

wherein x and (y+1) are integers of at least 7, preferably at least 9; said surfactants disclosed in U.S. Pat. No. 3,234,258 Morris, issued Feb. 8, 1966; U.S. Pat. No. 5,075,041 Lutz, issued Dec. 24, 1991; U.S. Pat. No. 5,349,101 Lutz et al., issued Sep. 20, 1994; and U.S. Pat. No. 5,389,277 Prieto, issued Feb. 14, 1995 each incorporated herein by reference;

d) C₁₀-C₁₈ alkyl alkoxy sulfates (AE_{X}S) wherein preferably x is from 1-7;

e) C₁₀-C₁₈ alkyl alkoxy carboxylates preferably comprising 1-5 ethoxy units;

f) C₁₂-C₁₈ alkyl ethoxylates, C₆-C₁₂ alkyl phenol alkoxylates wherein the alkoxylate units are a mixture of ethyleneoxy and propyleneoxy units, C₁₂-C₁₈ alcohol and C₆-C₁₂ alkyl phenol condensates with ethylene oxide/propylene oxide block polymers inter alia Pluronic® ex BASF which are disclosed in U.S. Pat. No. 3,929,678 Laughlin et al., issued Dec. 30, 1975, incorporated herein by reference;

g) Alkylpolysaccharides as disclosed in U.S. Pat. No. 4,565,647 Llenado, issued Jan. 26, 1986, incorporated herein by reference;

h) Polyhydroxy fatty acid amides having the formula:

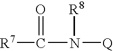

wherein R⁷ is C₅-C₃₁ alkyl; R⁸ is selected from the group consisting of hydrogen, C₁-C₄ alkyl, C₁-C₄ hydroxyalkyl, Q is a polyhydroxyalkyl moiety having a linear alkyl chain with at least 3 hydroxyls directly connected to the chain, or an alkoxylated derivative thereof; preferred alkoxy is ethoxy or propoxy, and mixtures thereof; preferred Q is derived from a reducing sugar in a reductive amination reaction, more preferably Q is a glycityl moiety; Q is more preferably selected from the group consisting of —CH₂(CHOH)ₙCH₂OH, —CH(CH₂OH)(CHOH)ₙ₋₁CH₂OH, —CH₂(CHOH)₂—(CHOR′)(CHOH)CH₂OH, and alkoxylated derivatives thereof, wherein n is an integer from 3 to 5, inclusive, and R′ is hydrogen or a cyclic or aliphatic monosaccharide, which are described in U.S. Pat. No. 5,489,393 Connor et al., issued Feb. 6, 1996; and U.S. Pat. No. 5,45,982 Murch et al., issued Oct. 3, 1995, both incorporated herein by reference.

The detergent compositions of the present invention can also comprise from 0.001% to 100% by weight, of the surfactant system of one or more (preferably a mixture of two or more) mid-chain branched surfactants, preferably mid-chain branched alkyl alkoxy alcohols having the formula:

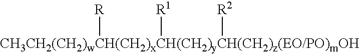

mid-chain branched alkyl sulfates having the formula:

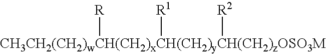

and mid-chain branched alkyl alkoxy sulfates having the formula:

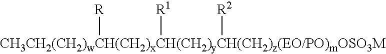

wherein the total number of carbon atoms in the branched primary alkyl moiety of these formulae (including the R, R¹, and R² branching, but not including the carbon atoms which comprise any EO/PO alkoxy moiety) is from 14 to 20, and wherein further for this surfactant mixture the average total number of carbon atoms in the branched primary alkyl moieties having the above formula is within the range of greater than 14.5 to 17.5 (preferably from 15 to 17); R, R¹, and R² are each independently selected from hydrogen, C₁-C₃ alkyl, and mixtures thereof, preferably methyl; provided R, R¹, and R² are not all hydrogen and, when z is 1, at least R or R¹ is not hydrogen. M is a water soluble cation and may comprises more than one type of cation, for example, a mixture of sodium and potassium. The index w is an integer from 0 to 13; x is an integer from 0 to 13; y is an integer from 0 to 13; z is an integer of at least 1; provided w+x+y+z is from 8 to 14. EO and PO represent ethyleneoxy units and propyleneoxy units having the formula:

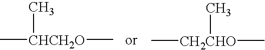

respectively, however, other alkoxy units inter alia 1,3-propyleneoxy, butoxy, and mixtures thereof are suitable as alkoxy units appended to the mid-chain branched alkyl moieties.

The mid-chain branched surfactants are preferably mixtures which comprise a surfactant system. Therefore, when the surfactant system comprises an alkoxylated surfactant, the index m indicates the average degree of alkoxylation within the mixture of surfactants. As such, the index m is at least 0.01, preferably within the range of from 0.1, more preferably from 0.5, most preferably from 1 to 30, preferably to 10, more preferably to 5. When considering a mid-chain branched surfactant system which comprises only alkoxylated surfactants, the value of the index m represents a distribution of the average degree of alkoxylation corresponding to m, or it may be a single specific chain with alkoxylation (e.g., ethoxylation and/or propoxylation) of exactly the number of units corresponding to m.

The preferred mid-chain branched surfactants which are suitable for use in the surfactant systems of the present invention have the formula:

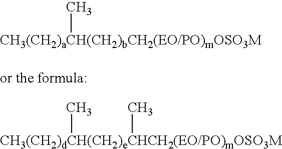

wherein a, b, d, and e are integers such that a+b is from 10 to 16 and d+e is from 8 to 14; M is selected from sodium, potassium, magnesium, ammonium and substituted ammonium, and mixtures thereof.

The surfactant systems which comprise mid-chain branched surfactants are preferably formulated in two embodiments. A first preferred embodiment comprises mid-chain branched surfactants which are formed from a feedstock which comprises 25% or less of mid-chain branched alkyl units. Therefore, prior to admixture with any other conventional surfactants, the mid-chain branched surfactant component will comprise 25% or less of surfactant molecules which are non-linear surfactants.

A second preferred embodiment comprises mid-chain branched surfactants which are formed from a feedstock which comprises from 25% to 70% of mid-chain branched alkyl units. Therefore, prior to admixture with any other conventional surfactants, the mid-chain branched surfactant component will comprise from 25% to 70% surfactant molecules which are non-linear surfactants.

The surfactant systems of the detergent compositions of the present invention can also comprise from 0.001%, preferably from 1%, more preferably from 5%, most preferably from 10% to 100%, preferably to 60%, more preferably to 30% by weight, of the surfactant system, of one or more (preferably a mixture of two or more) mid-chain branched alkyl arylsulfonate surfactants, preferably surfactants wherein the aryl unit is a benzene ring having the formula:

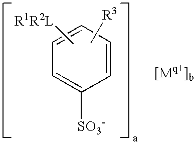

wherein L is an acyclic hydrocarbyl moiety comprising from 6 to 18 carbon atoms; R¹, R², and R³ are each independently hydrogen or C₁-C₃ alkyl, provided R¹ and R² are not attached at the terminus of the L unit; M is a water soluble cation having charge q wherein a and b are taken together to satisfy charge neutrality.

(b) Builders

The detergent composition and/or the granule of the present invention can further comprise builders. Suitable water-soluble builder compounds for use herein include water soluble monomeric polycarboxylates or their acid forms, homo- or co-polymeric polycarboxylic acids or their salts in which the polycarboxylic acid comprises at least two carboxylic radicals separated from each other by not more than two carbon atoms, carbonates, bicarbonates, borates, phosphates, and mixtures thereof.

The carboxylate or polycarboxylate builder can be monomeric or oligomeric in type although monomeric polycarboxylates are generally preferred. Suitable carboxylates containing one carboxy group include the water soluble salts of lactic acid, glycolic acid and ether derivatives thereof. Polycarboxylates containing two carboxy groups include the water-soluble salts of succinic acid, malonic acid, (ethylenedioxy) diacetic acid, maleic acid, diglycolic acid, tartaric acid, tartronic acid and fumaric acid as well as the ether carboxylates and the sulfinyl carboxylates. Polycarboxylates containing three carboxy groups include, in particular, water-soluble citrates, aconitrates and citraconates as well as succinate derivatives such as the carboxymethyloxysuccinates described in GB-A-1,379,241, lactoxysuccinates described in GB-A-1,389,732, amino-succinates described in NL-A-7205873, the oxypolycarboxylate materials described in GB-A-1,387,447. Polycarboxylates containing four carboxy groups suitable for use herein include those disclosed in GB-A-1,261,829. Polycarboxylates containing sulfo substituents include the sulfosuccinates derivatives disclosed in GB-A-1,398,421, GB-A-1,398,422 and U.S. Pat. No. 3,936,448 and the sulfonated pyrolysed citrates described in GB-A-1,439,000. Alicyclic and heterocyclic polycarboxylates include cyclopentane-cis,cis,cis-tetracarboxylates, 2,5-tetrahydrofuran-cis-dicarboxylates, 2,2,5,5-tetra-hydrofuran-tetracarboxylates, 1,2,3,4,5,6-hexane-hexacarboxylates and carboxymethyl derivatives of polyhydric alcohols such as sorbitol, mannitol and xylitol. Aromatic polycarboxylates include mellitic acid, pyromellitic acid and phthalic acid derivatives disclosed in GB-A-1,425,343. Preferred polycarboxylates are hydroxycarboxylates containing up to three carboxy groups per molecule, more particularly citrates. The parent acids of monomeric or oligomeric polycarboxylate chelating agents or mixtures thereof with their salts e.g. citric acid or citrate/citric acid mixtures are also contemplated as useful builders. Examples of carbonate builders are the alkaline earth and alkali metal carbonates, including sodium carbonate and sesqui-carbonate and mixtures thereof with ultra-fine calcium carbonate as disclosed in DE-A-2,321,001.

Suitable examples of phosphate builders are the alkali metal tripolyphosphates, sodium, potassium and ammonium pyrophosphate, sodium and potassium and ammonium pyrophosphate, sodium and potassium orthophosphate, sodium polymeta/phosphate in which the degree of polymerization ranges from 6 to 21, and salts of phytic acid. A preferred phosphate builder is sodium tripolyphosphate.

Suitable partially water-soluble builder compounds for use herein include crystalline layered silicates as disclosed in EP-A-164,514 and EP-A-293,640. Preferred crystalline layered sodium silicates of general formula:

NaMSiₓO₂₊₁.yH₂O

wherein M is sodium or hydrogen, x is a number from 1.9 to 4 and y is a number from 0 to 20. Crystalline layered sodium silicates of this type preferably have a two dimensional sheet structure, such as the so called δ-layered structure as described in EP-A-164,514 and EP-A-293,640. Methods of preparation of crystalline layered silicates of this type are disclosed in DE-A-3,417,649 and DE-A-3,742,043. A more preferred crystalline layered sodium silicate compound has the formula δ-Na₂Si₂O₅, known as NaSKS-6™ available from Hoeschst AG.

Suitable largely water-insoluble builder compounds for use herein include the sodium aluminosilicates. Suitable aluminosilicates include the aluminosilicate zeolites having the unit cell formula Na_{z}[(AlO₂)_{z}(SiO₂)_{y}].xH2O wherein z and y are at least 6, the molar ratio of z to y is from 1 to 0.5 and x is at least 5, preferably from 7.5 to 276, more preferably from 10 to 264. The aluminosilicate material are in hydrated form and are preferably crystalline, containing from 10% to 28%, more preferably from 10% to 22% water in bound form. The aluminosilicate zeolites can be naturally occurring materials but are preferably synthetically derived. Synthetic crystalline aluminosilicate ion exchange materials are available under the designations Zeolite A, Zeolite B, Zeolite P, Zeolite X, and Zeolite HS. Preferred, aluminosilicate zeolites are colloidal aluminosilicate zeolites. When employed as a component of a detergent composition colloidal aluminosilicate zeolites, especially colloidal zeolite A, provide enhanced builder performance, especially in terms of improved stain removal, reduced fabric encrustation and improved fabric whiteness maintenance. Mixtures of colloidal zeolite A and colloidal zeolite Y are also suitable herein providing excellent calcium ion and magnesium ion sequestration performance.

The detergent composition herein preferably comprises a builder, typically present at a level of from 1% to 80% by weight, preferably from 10% to 70% by weight, most preferably from 20% to 60% by weight of the detergent composition.

(c) Perfumes

The detergent composition and/or the granule of the present invention can further comprise a perfume component. This perfume component can comprise an encapsulate perfume, a properfume, neat perfume materials, and mixtures thereof. A wide variety of chemicals are known for perfumery uses, including materials such as aldehydes, ketones, esters and the like. More commonly, naturally occurring plant and animal oils and exudates comprising complex mixtures of various chemicals components are known for use as perfumes, and such materials can be used herein. The perfumes herein can be relatively simple in their composition or can comprise highly sophisticated, complex mixtures of natural and synthetic chemical components, all chosen to provide any desired odor. The invention also encompasses the use of materials which act as malodor counteractants. These materials, although termed “perfumes” hereinafter, may not themselves have a discernible odor but can conceal or reduce any unpleasant doors. Examples of suitable malodor counteractants are disclosed in U.S. Pat. No. 3,102,101, issued Aug. 27, 1963, to Hawley et al.

By encapsulated perfumes it is meant perfumes that are encapsulated within a capsule comprising an encapsulating material or a perfume which is loaded onto a, preferably porous, carrier material which is then preferably encapsulated within a capsule comprising an encapsulating material. A wide variety of capsules exist which will allow for delivery of perfume effect at various times during the use of the detergent compositions. Examples of such capsules with different encapsulated materials are capsules provided by microencapsulation. Here the perfume comprises a capsule core which is coated completely with a material which may be polymeric. U.S. Pat. No. 4,145,184, Brain et al, issued Mar. 20, 1979, and U.S. Pat. No. 4,234,627, Schilling, issued Nov. 18, 1980, teach using a tough coating material which essentially prohibits the diffusions out of the perfume. The encapsulating materials of the perfumed particles is preferably a water-soluble or water-dispersible encapsulating material. Nonlimiting examples of suitable water-soluble coating materials include such substances as methyl cellulose, maltodextrin and gelatin. Especially suitable water-soluble encapsulating materials are as described in GB-A-1,464,616 and in U.S. Pat. No. 3,455,838.

The perfume component may alternatively comprise a pro-perfumes. Pro-perfumes are perfume precursors which release the perfume on interaction with an outside stimulus for example, moisture, pH, and chemical reaction. Pro-perfumes suitable for use herein include those known in the art. Suitable pro-perfumes can be found in the art including U.S. Pat. Nos. 4,145,184, Brain and Cummins, issued Mar. 20, 1979; 4,209,417, Whyte, issued Jun. 24, 1980; 4,545,705, Moeddel, issued May 7, 1985; and 4,152,272, Young, issued May 1, 1979; U.S. Pat. No. 5,139,687 Borcher et al. Issued Aug. 18, 1992 and U.S. Pat. No. 5,234,610 Gardlik et al. Issued Aug. 10, 1993.

The detergent compositions typically comprise perfume component at a level of from 0.05% to 15%, preferably from 0.1% to 10%, most preferably from 0.5% to 5% by weight of the composition.

(d) Fabric Softeners

The detergent composition and/or the granule of the present invention can further comprise a fabric softener. Preferred are cationic fabric softeners. Any suitable cationic fabric softener may be used herein. Typically, the detergent composition comprise from 0.01% to 40% by weight of the detergent composition, more preferably from 0.1% to 15% by weight of the detergent composition, even more preferably 0.5% to 5% by weight of detergent composition, of cationic fabric softener. Preferably, the cationic fabric softener for use herein is selected from quaternary ammonium agents. As used herein the term “quaternary ammonium agent’ means a compound or mixture of compounds having a quaternary nitrogen atom and having one or more, preferably two, moieties containing six or more carbon atoms. Preferably the quaternary ammonium agents for use herein are selected from those having a quaternary nitrogen substituted with two moieties wherein each moiety comprises ten or more, preferably 12 or more, carbon atoms.

(e) Enzymes

The detergent composition and/or the granule of the present invention can further comprise enzymes. Suitable enzymes include enzymes selected from peroxidases, proteases, gluco-amylases, amylases, xylanases, cellulases, lipases, phospholipases, esterases, cutinases, pectinases, keratanases, reductases, oxidases, phenoloxidases, lipoxygenases, ligninases, pullulanases, tannases, pentosanases, malanases, B-glucanases, arabinosidases, hyaluronidase, chondroitinase, dextranase, transferase, laccase, mannanase, xyloglucanases, or mixtures thereof. Detergent compositions generally comprise a cocktail of conventional applicable enzymes like protease, amylase, cellulase, and lipase.

Enzymes are generally incorporated in detergent compositions at a level of from 0.0001% to 2%, preferably from 0.001% to 0.2%, more preferably from 0.005% to 0.1% pure enzyme by weight of the composition.

Suitable proteases are the subtilisins which are obtained from particular strains of B. subtilis, B. licheniformis and B. amyloliquefaciens (subtilisin BPN and BPN′), B. alcalophilus and B. lentus. Suitable Bacillus protease is Esperease® with maximum activity at pH 8-12, sold by Novozymes and described with its analogues in GB 1,243,784. Other suitable proteases include Alcalase®, Everlase® and Savinase® from Novozymes. Proteolytic enzymes also encompass modified bacterial serine proteases, such as those described in EP 251 446 (particularly pages 17, 24 and 98), referred to as “Protease B”, and in EP 199 404 which refers to a modified enzyme referred to as “Protease A”. Also suitable is the enzyme called “Protease C”, which is a variant of an alkaline serine protease from Bacillus (WO 91/06637). A preferred protease referred to as “Protease D” is a carbonyl hydrolase variant having an amino acid sequence not found in nature, described in WO95/10591 and WO95/10592. Preferred proteases are multiply-substituted protease variants comprising a substitution of an amino acid residue at positions corresponding to positions 103 and 76, there is also a substitution of an amino acid residue at one or more amino acid residue positions other than amino acid residue positions corresponding to positions 27, 99, 101, 104, 107, 109, 123, 128, 166, 204, 206, 210, 216, 217, 218, 222, 260, 265 or 274 of Bacillus amyloliquefaciens subtilisin. WO 99/20723, WO99/20726, WO99/20727, WO99/20769, WO99/20770 and WO99/20771 describe also suitable proteases, wherein preferred variants have the amino acid substitution set 101/103/104/159/232/236/245/248/252, more preferably 101G/103A/104I/159D/232V/236H/245R/248D/252K according to the BPN′ numbering.

Amylases (α and/or β) can be included for removal of carbohydrate-based stains. Suitable amylases are described in WO94/02597 and WO95/10603 (both Novozymes). WO95/26397 describes other suitable amylases: α-amylases characterized by having a specific activity at least 25% higher than the specific activity of Termamyl® at a temperature range of 25° C. to 55° C. and at a pH value in the range of 8 to 10, measured by the Phadebas® α-amylase activity assay. Suitable variants of the above enzymes are described in WO96/23873 (Novozymes). Preferred variants therein are those with increased thermostability described on p16 of WO96/23873, and especially the D183*+G184*. Examples of commercial α-amylases products are Purafect Ox Am® from Genencor and Termamyl®, Ban®, Fungamyl® and Duramyl®, all available from Novozymes.

Suitable cellulases include both bacterial and fungal cellulases, preferably with a pH optimum of between 5 and 12. Examples are cellulases produced by a strain of Humicola insolens (Humicola grisea var. thermoidea), particularly the Humicola strain DSM 1800. Other suitable cellulases are cellulases originated from Humicola insolens having a molecular weight of 50 KDa, an isoelectric point of 5.5 and containing 415 amino acids; and a ^{˜}43 kD endoglucanase derived from Humicola insolens, DSM 1800, exhibiting cellulase activity; a preferred endoglucanase component has the amino acid sequence disclosed in WO 91/17243. Also suitable cellulases are the EGIII cellulases from Trichoderma longibrachiatum (WO94/21801, Genencor). Especially suitable cellulases are the cellulases having color care benefits such as described in EP 495 257. Carezyme® and Celluzyme® commercially available from Novozymes are especially useful. Other suitable cellulases for fabric care and/or cleaning properties are described in WO96/34092, WO96/17994 WO95/24471, WO91/17244 and WO91/21801.

Suitable lipases include those produced by the Pseudomonas group, such as P. stutzeri ATCC 19.154 (GB1,372,034). Suitable lipases include those showing a positive immunological cross-reaction with the antibody of the Pseudomonas fluorescent Ilipase AM 1057 available from Amano Pharmaceutical Co. Ltd Japan, under the trade name “Lipase P Amano”. Other suitable commercial lipases include Amano-CES, lipases ex Chromobacter viscosum, e.g. Chromobacter viscosum var. lipolyticum NRRLB 3673 from Toyo Jozo Co., Tagata, Japan; Chromobacter viscosum lipases from U.S. Biochemical Corp., U.S.A. and Disoynth Co., The Netherlands; and lipases ex Pseudomonas gladioli. Especially suitable are the lipases produced by Pseudomonas pseudoalcaligenes (EP 218 272) or variants thereof (WO9425578) previously supplied by Gist-Brocades as M1 Lipase^{R and} Lipomax^{R}. Preferred lipases are the Lipolase^{R} and Lipolase Ultra^{R} from Novozymes. Also suitable are the enzymes described in EP 258 068, EP 943678, WO 92/05249, WO 95/22615, WO 9942566, WO 200060063 (all by Novozymes) and in WO 94/03578, WO 95/35381 and WO 96/00292 by Unilever.

Also suitable are cutinases [EC 3.1.1.50] being considered as lipases which do not require interfacial activation. Suitable cutinases are described in WO88/09367 (Genencor); WO 90/09446 (Plant Genetic System); WO94/14963 and WO94/14964 (Unilever) and WO00/344560 (Novozymes).

Also suitable are bleaching enzymes, the following starch degrading enzymes: Cyclomaltodextrin glucanotransferase “CGTase” (E.C. 2.4.1.19), maltogenic alpha amylase (E.C. 3.2.1.133) and amyloglucosidase (E.C. 3.2.1.3); and the following carbohydrases: Mannanase (E.C. 3.2.1.78), protopectinase, polygalacturonase (E.C. 3.2.1.15), pectin lyase (E.C. 4.2.2.10), pectin esterase (E.C. 3.1.1.11), pectate lyase (E.C. 4.2.2.2) and Xyloglucanase.

(f) Optical Brightener

The detergent composition and/or the granule of the present invention can further comprise optical brighteners. If present, detergent compositions herein preferably contain from 0.005% to 5% by weight of detergent composition of hydrophilic optical brighteners.

Hydrophilic optical brighteners useful herein include those having the structural formula:

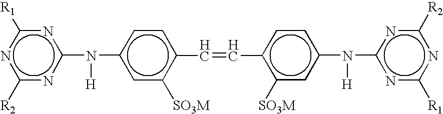

wherein R₁ is selected from anilino, N-2-bis-hydroxyethyl and NH-2-hydroxyethyl; R₂ is selected from N-2-bis-hydroxyethyl, N-2-hydroxyethyl-N-methylamino, morphilino, chloro and amino; and M is a salt-forming cation such as sodium or potassium.

When in the above formula, R₁ is anilino, R₂ is N-2-bis-hydroxyethyl and M is a cation such as sodium, the brightener is 4,4′,-bis[(4-anilino-6-(N-2-bis-hydroxyethyl)-s-triazine-2-yl)amino]-2,2′-stilbenedisulfonic acid and disodium salt. This particular brightener species is commercially marketed under the tradename Tinopal-UNPA-GX by Ciba-Geigy Corporation. Tinopal-UNPA-GX is the preferred hydrophilic optical brightener useful in the detergent compositions herein.

When in the above formula, R₁ is anilino, R₂ is N-2-hydroxyethyl-N-2-methylamino and M is a cation such as sodium, the brightener is 4,4′-bis[(4-anilino-6-(N-2-hydroxyethyl-N-methylamino)-s-triazine-2-yl)amino]2,2′-stilbenedisulfonic acid disodium salt. This particular brightener species is commercially marketed under the tradename Tinopal 5BM-GX by Ciba-Geigy Corporation.

When in the above formula, R₁ is anilino, R₂ is morphilino and M is a cation such as sodium, the brightener is 4,4′-bis[(4-anilino-6-morphilino-s-triazine-2-yl)amino]2,2′-stilbenedisulfonic acid, sodium salt. This particular brightener species is commercially marketed under the tradename Tinopal AMS-GX by Ciba Geigy Corporation.

Other preferred optical brighteners are those known as Brightener 49 available from Ciba-Geigy.

(g) Bleaching System

The detergent composition and/or the granule of the present invention can further comprise a bleaching system which preferably comprises a perhydrate bleach, such as salts of percarbonates, particularly the sodium salts, and/or organic peroxyacid bleach precursor, and/or transition metal bleach catalysts, especially those comprising Mn or Fe.

Inorganic perhydrate salts are a preferred source of peroxide. Examples of inorganic perhydrate salts include percarbonate, perphosphate, persulfate and persilicate salts. The inorganic perhydrate salts are normally the alkali metal salts. Alkali metal percarbonates, particularly sodium percarbonate are preferred perhydrates herein.

The bleaching system preferably comprises a peroxy acid or a precursor therefor (bleach activator), preferably comprising an organic peroxyacid bleach precursor. It may be preferred that the composition comprises at least two peroxy acid bleach precursors, preferably at least one hydrophobic peroxyacid bleach precursor and at least one hydrophilic peroxy acid bleach precursor, as defined herein. The production of the organic peroxyacid occurs then by an in-situ reaction of the precursor with a source of hydrogen peroxide. The hydrophobic peroxy acid bleach precursor preferably comprises a compound having a oxy-benzene sulphonate group, preferably NOBS, DOBS, LOBS and/or NACA-OBS, as described herein. The hydrophilic peroxy acid bleach precursor preferably comprises TAED.

Amide substituted alkyl peroxyacid precursor compounds can be used herein. Suitable amide substituted bleach activator compounds are described in EP-A-0170386.

The detergent composition may contain a pre-formed organic peroxyacid. A preferred class of organic peroxyacid compounds are described in EP-A-170,386. Other organic peroxyacids include diacyl and tetraacylperoxides, especially diperoxydodecanedioc acid, diperoxytetradecanedioc acid and diperoxyhexadecanedioc acid. Mono- and diperazelaic acid, mono- and diperbrassylic acid and N-phthaloylaminoperoxicaproic acid are also suitable herein.

When present, bleaching systems will typically be at levels of from 1%, preferably from 5% to 30%, preferably to 20% by weight of the composition. A description of other suitable bleaches can be found in WO-A-00/04129.

(h) Chelating Agents

The detergent composition and/or the granule of the present invention can further comprise chelants/heavy metal ion sequestrants as the benefit agent. By heavy metal ion sequestrant it is meant herein components which act to sequester (chelate) heavy metal ions. These components may also have calcium and magnesium chelation capacity, but preferentially they show selectivity to binding heavy metal ions such as iron, manganese and copper.

Heavy metal ion sequestrants are generally present at a level of from 0.005% to 20% by weight of the detergent composition, preferably from 0.1% to 10% by weight of the detergent composition, more preferably from 0.25% to 7.5% by weight of the detergent composition and most preferably from 0.5% to 5% by weight of the detergent composition.

Heavy metal ion sequestrants, which are acidic in nature, having for example phosphonic acid or carboxylic acid functionalities, may be present either in their acid form or as a complex/salt with a suitable counter cation such as an alkali or alkaline metal ion, ammonium, or substituted ammonium ion, or any mixtures thereof. Preferably any salts/complexes are water soluble. The molar ratio of said counter cation to the heavy metal ion sequestrant is preferably at least 1:1.

Suitable heavy metal ion sequestrants for use herein include organic phosphonates, such as the amino alkylene poly (alkylene phosphonates), alkali metal ethane 1-hydroxy disphosphonates and nitrilo trimethylene phosphonates. Preferred among the above species are diethylene triamine penta (methylene phosphonate), ethylene diamine tri (methylene phosphonate) hexamethylene diamine tetra (methylene phosphonate) and hydroxy-ethylene 1,1 diphosphonate.

Other suitable heavy metal ion sequestrant for use herein include nitrilotriacetic acid and polyaminocarboxylic acids such as ethylenediaminotetracetic acid, ethylenetriamine pentacetic acid, ethylenediamine disuccinic acid, ethylenediamine diglutaric acid, 2-hydroxypropylenediamine disuccinic acid or any salts thereof.

Especially preferred is ethylenediamine-N,N′-disuccinic acid (EDDS) or the alkali metal, alkaline earth metal, ammonium, or substituted ammonium salts thereof, or mixtures thereof. Preferred EDDS compounds are the free acid form and the sodium or magnesium salt or complex thereof.

(i) Suds Suppressors

The detergent composition and/or the granule of the present invention can further comprise a suds suppressing system present. The suds suppressing system is generally present at a level of from 0.01% to 15% by weight of the detergent composition, preferably from 0.05% to 10% by weight of the detergent composition, most preferably from 0.1% to 5% by weight of the detergent composition.

Suitable suds suppressing systems for use herein may comprise essentially any known antifoam compound, including, for example silicone antifoam compounds, 2-alkyl and alcanol antifoam compounds. Preferred suds suppressing systems and antifoam compounds are disclosed in WO-A-93/08876 and EP-A-705 324.

Other Ingredients

The granule and/or the detergent compositions herein can comprise any other material or mixture of materials suitable for a detergent composition. For example, wrinkle reducing agents (such as those found in WO-A-99/55953), fabric abrasion reducing polymers (such as those that are described in WO-A-00/15745), chlorine scavengers (such as ammonium chloride), dye fixing agents, antifoam compounds such as those disclosed in WO-A-93/08876 and EP-A-705 324), polymeric dye transfer inhibiting agents, soil release agents (such as those described in U.S. Pat. Nos. 4,968,451, 4,711,730, 4,721,580, 4,702,857, 4,877,896), clay softening system (such as those described in U.S. Pat. Nos. 3,862,058, 3,948,790, 3,954,632, 4,062,647, EP-A-299,575 and EP-A-313,146), alkali metal silicate, colorant, lime soap dispersant (such as those described in WO-A-93/08877), and compatible mixtures thereof.

The Process of Making the Granule and Form of the Detergent Composition

The granule of the present invention can be produced by any process wherein the nonionic surfactant and the hydrotrope, and optionally further ingredients are mixed together to form a mixture, and then forming the mixture into granules. The mixture may be formed into granules by for example an extrusion process, a fluid bed process, rotary atomization, agglomeration or a molding process. Preferably, the granules are formed by an agglomeration and/or an extrusion process. The agglomeration and also the extrusion process provide a simple, fast, efficient, cost-effective means of preparing a granule.

Any type of mixer may be used to prepare the mixture, especially a dynamic mixer. The mixing equipment will need to be selected to handle the relatively high viscosities that the mixture will reach. The exact viscosity will depend on the composition of the mixture and on the processing temperature. Preferably the processing temperature is below 120° C., preferably below 100° C., more preferably below 80° C., and most preferably between 40° C. and 75° C.

The mixture may be subsequently granulated by various process means. Preferred means are described in more detail below:

Fine Dispersion Mixing and Granulation

Suitable pieces of equipment in which to carry out the fine dispersion mixing or granulation of the present invention are mixers of the Fukae® FS-G Series manufactured by Fukae Powtech Kogyo Co. Japan. This apparatus is essentially in the form of a bowl-shaped vessel accessible via a top port, provided near its base with a stirrer having substantially vertical axis, and a cutter positioned on a side wall. The stirrer and cutter may be operated independently of one another and at separately variable speeds. The vessel can be fitted with a heating or cooling jacket.

Other similar mixers found to be suitable for use in the process of the invention include Diosna® V series ex Dierks & Söhne, Germany; and the Pharma Matrix® ex T K Fielder Ltd., England. Other mixers believed to be suitable for use in the process of the invention are the Fuji® VG-C series ex Fuji Sangyo Co., Japan; and the Roto® ex Zanchetta & Co srl, Italy.

Other preferred suitable equipment can include Eirich® Series R and RV, manufactured by Gustau Eirich Hardheim, Germany; Lödige, Series FM for batch mixing or series CB and KM, either separately or in series for continues mixing/agglomeration, manufactured by Lödige Maschinenbau GmbH, Paderborn Germany; Drais® T 160 Series, manufactured by Drais Werke GmbH, Mannheim, Germany; and Winkworth® RT 25 series, manufactured by Winkworth Manchinery Ltd., Berkshire, England.

The Littleford Mixer, Model #FM-130-D-12, with internal chopping blades and the Cuisinart Food Processor, Model #DCX-Plus, with 7.75 inch (19.7 cm) blades are two more examples of suitable mixers. Any other mixer with fine dispersion mixing and granulation capability and having a residence time in the order of 0.1 to 10 minutes can be used. The “turbine-type” impeller mixer, having several blades on an axis of rotation, is preferred. The invention can be practiced as a batch or a continuous process.

The following exemplifies the mixing and agglomeration process by which the detergent granule of the present invention can be produced.

The nonionic surfactant and the hydrotrope are mixed together in a colloid mill. When further adding optional adjunct materials like the hardening ingredient and/or the stickiness breaking materials and any others, the mixture can be transferred to a high shear mixer agglomerator (Eirich R-Series), at 1000 rpm to 3000 rpm in order to mix the components intimately. The granules are progressively formed. The mixing of the components is stopped when course granules are formed.

Further Processing Steps

The granule of the present invention obtained by the processes above is suitable for use directly, or may be treated by additional process steps such as the commonly used steps of cooling, and/or dusting the granules. In addition the granules of the present invention may be blended with other components in order to provide a detergent composition suitable for the desired end use. The granules can be screened through different sieves.

The weight mean particle size of the detergent granule of the present invention will generally be from 200 μm to 2000 μm, preferably being at least 300 μm and not above 1700 μm, preferably below 1600 μm. This weight mean particle size can for example be determined by sieve analysis, for example by sieving a sample of the particulate relevant material herein through a series of sieves, typically 5, with meshes of various diameter or aperture size, obtaining a number of fraction (thus having a particle size of above, below or between the mesh size of the used sieve size).

Preferably at least 70% or even at least 80% by weight of said granule has a particle size from 200 μm to 2000 μm, more preferably from 300 μm to 1700 μm, and most preferably from 380 to a 1550 μm.

The density of the granule according to the invention will generally be above 300 g/l, preferably greater than 400 g/l or even greater than 500 g/l. The density of the granule according to the invention will generally be below 1200 g/l, preferably below 900 g/l.

The granule of the present invention and the detergent composition comprising said granule of the present invention are generally substantially non-aqueous (or anhydrous) in character. While very small amounts of water may be incorporated into such granules and detergent compositions as an impurity in the raw materials, the amount of water should preferably not exceed 9% by weight of the granule or 9% by weight of the detergent composition herein. Preferably, the water-content of the granule of the present invention and of the detergent composition of the present invention is less than 7% by weight of the granule or 7% by weight of the detergent composition, more preferably less than 5% by weight of the granule or 5% by weight of the detergent composition herein and even most preferably less than 3% by weight of the granule or 3% by weight of the detergent composition herein.

The detergent composition of the present invention can be used in a conventional laundry machine via the dispensing drawer.

For convenience reasons consumers prefer detergent compositions in form of a tablet. These tablets are more easily to dose, to handle, to transport and to store. Those tablets are dosed to the laundry machine via the dispensing drawer. When the compositions of the present invention are tablets they can be prepared simply by mixing the solid ingredients together and compressing the mixture in a conventional tablet press as used, for example, in the pharmaceutical industry. The tablets are preferably compressed at a force of not more than 10000 N/cm², more preferably not more than 3000 N/cm², even more preferably not more than 750 N/cm². Suitable equipment includes a standard single stroke or a rotary press (such as is available form Courtoy®, Korsch®, Manesty® or Bonals®). Preferably the tablets are prepared by compression in a tablet press capable of preparing a tablet comprising a mould. Multi-phase tablets can be made using known techniques. The tablets herein preferably have a diameter of between 20 mm and 60 mm, preferably of at least 35 mm and up to 55 mm, and a weight of between 25 and 100 grams. The ratio of height to diameter (or width) of the tablets is preferably greater than 1:3, more preferably greater than 1:2. In a preferred embodiment according to the invention, the tablet has a density of at least 0.5 g/cc, more preferably at least 1.0 g/cc, and preferably less then 2.0 g/cc, more preferably less than 1.5 g/cc.

Processes for preparing detergent tablets by compressing a granule to form a tablet have been intensively described in the prior art, i.e., GB 2 327 947 (P&G); WO 00/50559 (Henkel); EP 0 711 828 (Unilever); WO 01/48131 (Cognis); EP 0 971 028 and EP 0 971 029 (P&G); WO 98/42817 (Unilever); EP 0 598 586 (Unilever).

### EXAMPLES

The following examples further illustrate the preferred embodiments of the scope of the present invention. The examples are given solely for the purposes of illustration and are not to be construed as limitations of the present invention as many variations of the invention are possible without departing from its spirit or scope.

### Example I

The Granules

| % by weight of the | | | | | | | | |
|---|---|---|---|---|---|---|---|---|
| granule | 1 | 2 | 3 | 4 | 5 | 6 | 7 | 8 |
| Nonionic surfactant | 40 | — | — | — | 30 | 24 | — | 24 |
| (1) | | | | | | | | |
| Nonionic surfactant | — | 44 | — | 27 | — | 20 | — | — |
| (2) | | | | | | | | |
| Nonionic surfactant | — | — | 47 | — | — | — | 47 | 20 |
| (3) | | | | | | | | |
| Hydrotrope (4) | 60 | — | 27 | — | — | — | 12 | 24 |
| Hydrotrope (5) | — | 44 | — | — | — | 44 | 15 | 20 |
| Hydrotrope (6) | — | — | — | 27 | 10 | — | — | — |
| Zeolite | — | 12 | 9 | 30 | 60 | 12 | 9 | 12 |
| Thixatrol ST (7) | — | — | 17 | — | — | — | 17 | — |
| Polyethyleneglycol | — | — | — | 16 | — | — | — | — |
| (MW = 4000) | | | | | | | | |

(1): Blend of C₁₄, and C₁₅ alcohols ethoxylated with 7 eq. moles of ethylene oxide on average (Neodol ® 45-AE 7) ex Shell;
(2): Blend of C₁₄, and C₁₅ alcohols ethoxylated with 5 eq. moles of ethylene oxide on average (Neodol ® 45-AE 5) ex Shell;
(3): Blend of C₁₂, and C₁₃ alcohol polyethylene glycol ethers with 3 eq. of ethylene oxide on average, liquid branched alcohol ethoxylates (Lealed ® 125-AB 3);
(4): Sodium toluene sulfonate;
(5): Sodium cumene sulfonate;
(6): Sodium xylene sulfonate;
(7): Commercially available derivative of castor oil, mainly comprising ricinoleic (hydroxyl) acid, and sold by RHEOX.

Such granules have a mean particle sizes around 400 μm when manufactured by agglomeration and around 1500 μm, when manufacture by an extrusion process. The density is around 630 g/l.

Method of Making the Granule

1, Granule 1:

A centrifugal (Goulds) pump feeds 1200 gr/min of Neodol 45-AE 7 through a continuous liquid/solid mixer (AEA technology) together with 1800 g/min of sodium toluene sulphonate which is added via a LIW feeder (Rospen). This mix is sent through a colloid mill (Fryma) for intimately mixing. This mixture is then transferred into an extruder and pressed through a die plate with holes of 1 mm to 5 mm. The extrudates are added to a Marumerizer (Fuji Paudal) and granules are made.

2, Granule 2:

A centrifugal (Goulds) pump feeds 1200 gr/min of Neodol 45-AE 5 through a continuous liquid/solid mixer (AEA technology) together with 1200 gr/min of sodium toluene sulphonate which is added by a LIW feeder (Rospen). This mix is sent through a colloid mill (Fryma) for intimately mixing. This mix is then added to an extruder (ZSK 25 Werner & Fleiderer) together with 330 gr/min Zeolite that is added with a LIW feeder (Rospen). In the extruder the components are intimately mixed with each other and pressed through a die plate with holes of 1 to 5 mm. The extrudates are added to a Marumerizer (Fuji Paudal) and granules are made.

3, Granule 3:

A centrifugal (Goulds) pump feeds 520 gr/min of Neodol 45-AE 7 through a continuous liquid/solid mixer (AEA technology) together with 520 gr/min of cumene toluene sulphonate which is added by a LIW feeder (Rospen). This mix is sent through a colloid mill (Fryma) for intimately mixing. This mix is then added to an extruder (ZSK 25 Werner & Fleiderer) together with 296 gr/min of PEG 4000, which is added with a gear pump (MAAG). In the extruder the components are intimately mixed with each other and pressed through a die plate with holes of 1 to 5 mm. The extrudates are added together with 555 gr/min of zeolite (added via a LIW feeder from Rospen) to a Marumerizer (Fuji Paudal) and granules are made.

### Example II

Detergent Compositions:

A, Powder Detergent Composition.

| | % by weight of the | |
|---|---|---|
| Ingredient | composition | |
| Anionic agglomerates (1) | 27.0 | 20.0 |
| Granule composition 2 (see above) | 12.0 | 17.0 |
| Bleach activator agglomerates (2) | 6.0 | 8.0 |
| Zinc Phthalocyanine sulphonate encapsulate (3) | 0.1 | 0.2 |
| Suds suppressor (4) | 3.5 | 5.0 |
| Dried Zeolite | 7.0 | 10.0 |
| Layered Silicate (5) | 15.0 | 10.0 |
| Dye transfer inhibitor agglomerate (6) | 0.2 | 0.3 |
| Perfume encapsulates (7) | 0.3 | 0.5 |
| Fluorescer | 0.3 | 0.5 |
| Sodium carbonate | 5.0 | 4.0 |
| Sodium percarbonate | 20.1 | 21.0 |
| Sodium 1-hydroxyethyidene-1,1-diphoSphonic | 1.0 | 1.5 |
| acid | | |
| Soil release polymer | 0.2 | 0.5 |
| Perfume | 0.3 | 0.5 |
| Enzyme | 2.0 | 1.0 |
| | 100.0 | 100.0 |

(1) Anionic agglomerates comprise 38% anionic surfactant, 22% zeolite and 40% carbonate; mean particle size: 650 μm; density: 625 g/l.
(2) Bleach activator agglomerates comprise 81% TAED, 17% acrylic/maleic copolymer (acid form) and 2% water; mean particle size: 514 μm; density: 688 g/l.
(3) Zinc phthalocyanine sulphonate encapsulates are 10% active.
(4) Suds suppressor comprises 11.5% silicone oil (ex. Dow Coming) and 88.5% starch; mean particle size: 497 μm; density: 525 g/l.
(5) Layered silicate comprises 78% SKS-6, ex Hoechst, 22% citric acid.
(6) Dye transfer inhibitor agglomerates comprise 21% PVNO/PVPVI, 61% zeolite and 18% carbonate.
(7) Perfume encapsulates comprise 50% perfume and 50% starch.

B, Tablet Detergent Composition.

| | % by weight of the | |
|---|---|---|
| Ingredient | composition | |
| Anionic agglomerates 1 (1) | 11.0 | 13.0 |
| Anionic agglomerates 2 (2) | 17.0 | 12.0 |
| Granule composition 2 (see above) | 17.0 | 25.0 |
| Cationic agglomerates (3) | 5.0 | 8.1 |
| Layered silicate (4) | 10.0 | 8.0 |
| Sodium percarbonate | 12.0 | 10.0 |
| Bleach activator agglomerates (5) | 6.0 | 5.0 |
| Sodium carbonate | 7.0 | 6.0 |
| EDDS/Sulphate particle (6) | 0.5 | 0.4 |
| Tetrasodium salt of Hydroxyethane | 0.6 | 0.3 |
| Diphosphonic acid | | |
| Soil release polymer | 0.3 | 0.5 |
| Fluorescer | 0.2 | 0.3 |
| Zinc Phthalocyanine sulphonate encapsulate (7) | 0.1 | 0.2 |
| Soap powder | 1.3 | 2.0 |
| Suds suppresser (8) | 1.5 | 2.0 |
| Citric acid | 4.5 | 3.0 |
| Enzyme | 3.0 | 2.2 |
| Binder spray on system (9) | 3.0 | 2.0 |
| | 100.0 | 100.0 |

(1) Anionic agglomerates 1 comprise of 40% anionic surfactant, 27% zeolite and 33% carbonate; mean particle size: 630 μm; density: 620 g/l.
(2) Anionic agglomerates 2 comprise of 40% anionic surfactant, 28% zeolite and 32% carbonate; mean particle size: 635 μm; density: 615 g/l.
(3) Cationic agglomerate comprise of 20% cationic surfactant, 56% zeolite and 24% sulfate.
(4) Layered silicate comprises of 95% SKS 6 and 5% silicate; mean particle size: 469 μm; density: 901 g/l.
(5) Bleach activator agglomerates comprise of 81% Tetraacetylethylene diamine (TAED), 17% acrylic/maleic copolymer (acid form) and 2% water; mean particle size: 514 μm; density: 688 g/l.
(6) EDDS/Sulphate particle comprise of 58% of Ethylene diamine-N,N-disuccinic acid sodium salt, 23% of sulphate and 19% water.
(7) Zinc phthalocyanine sulphonate encapsulates are 10% active.
(8) Suds suppresser comprises of 11.5% silicone oil (ex Dow Coming), 59% zeolite and 29.5% water
(9) Binder spray on system comprises of 0.5 parts of Lutensit K-HD 96 and 2.5 parts of Polyethylene glycols (PEG.

What is claimed is:

1. A detergent granule comprising:
(a) a surfactant system comprising at least about 10% by weight of said surfactant system, of a nonionic surfactant; and
(b) a hydrotrope selected from the group consisting of unsubstituted- and substituted-phenyl, benzyl, alkyl, and alkenyl carboxylic acid and salts thereof; unsubstituted- and substituted-phenyl, benzyl, alkyl, and alkenyl sulfonic acid and salts thereof; unsubstituted- and substituted-phenyl, benzyl, alkyl, and alkenyl sulfuric acid and salts thereof; and mixtures thereof.

2. A granule according to claim 1 wherein the surfactant system comprises at least about 25% by weight of said surfactant system, of the nonionic surfactant.

3. A granule according to claim 2 wherein the surfactant system comprises at least about 50% by weight of said surfactant system, of the nonionic surfactant.

4. A granule according to claim 3 wherein the surfactant system comprises at least about 75% by weight of said surfactant system, of the nonionic surfactant.

5. A granule according to claim 1 wherein the surfactant system is present at a level of from about 10% to about 90% by weight of the granule.

6. A granule according to claim 1 wherein the hydrotrope is present at a level of from about 10% to about 90% by weight of the granule.

7. A granule according to claim 1 having a density between about 300 g/l and about 1200 g/l.

8. A granule according to claim 1 having a particle size between about 300 μm and about 1700 μm.

9. A granule according to claim 1 wherein the hydrotrope is selected from the group consisting of ortho-, meta- or para-toluene sulfonic acid sodium salt, xylene sulfonic acid sodium salt, cumene sulfonic acid sodium salt, benzene sulfonic acid sodium salt, ethylbenzene sulfonic acid sodium salt, disodium 1,3 benzenedisulfonate, and mixtures thereof.

10. A granule according to claim 1 further comprising a hardening ingredient.

11. A granule according to claim 10, wherein the hardening ingredient has a melting point above 30° C. and is selected from the group consisting of polyethylene glycols, polyethylene glycol esters, fatty alcohols alkoxylates, fatty acids and salts thereof, alkyl esters of sulfo fatty acids, glucose amides, amides, sorbitan esters, glycerol esters, polyglycol ethoxylated/propoxylated copolymers and mixtures thereof.

12. A granule according to claim 1 further comprising a stickiness breaking material.

13. A granule according to claim 12 wherein the stickiness breaking material is selected from the group consisting of zeolites, silicas, clays, amorphous silicates, fatty acid salts, i.e. calcium stearate, and magnesium stearate; titanium dioxide, calcium carbonate, cellulose, phosphates, crystalline non layered silicates, layered silicates, calcium/sodium carbonate double salt, sodium carbonate, alkali metal phosphonates, carboxyl alkyl celluloses, carboxyl alkyl starches, tetrasodium phosphate, citrates, alkali metal sulfates, and mixtures thereof.

14. A detergent composition comprising a granule according to claim 1.

15. A detergent composition according to claim 14 in form of a powder, or a tablet.

16. A method for making a detergent granule according to claim 1 comprising the step of mixing the hydrotrope with a nonionic surfactant.
